(19) United States
(12) Patent Application Publication
(10) Pub. No.: US 2010/0188379 A1
(43) Pub. Date: Jul. 29, 2010

(54) Display and Method for Driving the Same

(75) Inventors: Ying-Lieh Chen, Sinshih Township (TW); Wen-Teng Fan, Sinshih Township (TW); Chao-Ching Chi, Sinshih Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Himax Technologies Limited, Sinshih Township (TW)

(21) Appl. No.: 12/358,558

(22) Filed: Jan. 23, 2009

(51) Int. Cl. G06F 3/038

(52) U.S. Cl. 345/208

(57) ABSTRACT

A display comprises a panel, a gate driver and a plurality of source drivers. The panel comprises a plurality of pixels arranged in an array. The gate driver is provided for selectively activating a gate line of the panel. The source drivers, during a line period, receive a plurality of transfer pulses, each of which corresponds to one of the source drivers. The source drivers drive one row of the pixels corresponding to the activated gate line, while triggered by the corresponding transfer pulse, wherein the transfer pulses are not all identical. A method for driving a display is also disclosed herein.

### BACKGROUND

1. Field of Invention

The present invention relates to a display. More particularly, the present invention relates to a display driven with multi-timing-transfer-pulse technique.

2. Description of Related Art

A display includes at least a source driver, a gate driver and a timing controller. The source driver is triggered by a transfer pulse to start driving a horizontal line consisted of a row of pixels. When a transfer pulse is activated for the source driver to output driving voltages, a gate driving signal is activated is for the gate driver in accordance with the transfer pulse to drive a corresponding gate line for activating the row of pixels. However, when the gate driving signal drives the corresponding gate line, the gate driving signal would decay based on the transmission distance and the circuit loading, such that the gate driving signal is distorted at the end of the gate line, and thus the display may be inaccurately driven.

FIG. 1 illustrates a conventional timing diagram of the transmission of the start pulse and the gate driving signal. As shown in FIG. 1, when the transfer pulse TP1 is generated, the gate driving signal Gout_1 is generated for a corresponding gate line (e.g. 1^{st} gate line) in accordance with the transfer pulse TP1, and the gate driving signal Gout_1 would decay based on the IR drop (voltage drop) of the gate line.

Specifically, when the gate driving signal Gout_1 is initially generated to drive the gate line, the gate driving signal Gout_1 has a square waveform of the initial state (i.e. Gout_1_start). When the gate driving signal Gout_1 is transmitted for a certain distance, the gate driving signal Gout_1 becomes distorted to have a distorted waveform (i.e. Gout 1_end), which decays seriously because of the IR drop.

When the next transfer pulse is asserted, the distorted gate driving signal Gout_1_end does not end in time, as shown by sign A. As a result, the gate driving signal at the end of a first line Gout_1_end overlaps with the gate driving signal of a second line Gout_2_start, such that the display quality is greatly affected.

### SUMMARY

In accordance with one embodiment of the present invention, a display is provided. The display comprises a panel, a gate driver and a plurality of source drivers. The panel comprises a plurality of pixels arranged in an array. The gate driver is provided for selectively activating a gate line of the panel. The source drivers, during a line period, receive a plurality of transfer pulses, each of which corresponds to one of the source drivers. The source drivers drive one row of the pixels corresponding to the activated gate line, while triggered by the corresponding transfer pulse, wherein the transfer pulses are not all identical.

In accordance with another embodiment of the present invention, a method for driving a display is provided, in which the display including a plurality of source drivers and a panel. The method comprises the steps of: receiving a plurality of transfer pulses, during a line period, respectively corresponding to the source drivers, wherein the transfer pulse signals are not all identical; and driving the panel by the corresponding source drivers upon receiving the corresponding transfer pulse.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference to the accompanying drawings as follows:

FIG. 1 illustrates a conventional timing diagram of the transmission of the start pulse and the gate driving signal;

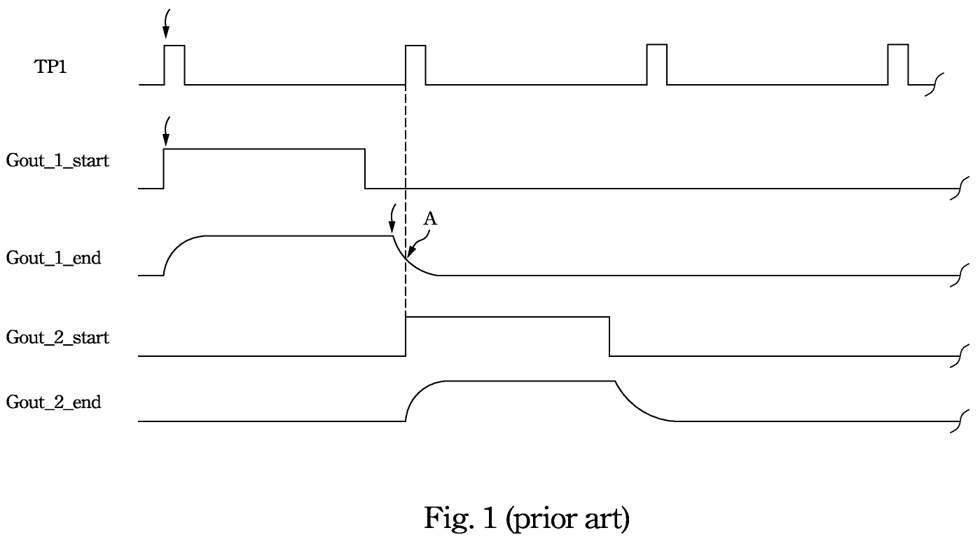

FIG. 2 illustrates a display according to an embodiment of the invention;

FIG. 3 illustrates a timing diagram of the transfer pulse and the gate driving signal according to one embodiment of the present invention; and

FIG. 4 illustrates a display according to another embodiment of the present invention.

### DESCRIPTION OF THE PREFERRED EMBODIMENTS

In the following detailed description, the embodiments of the present invention have been shown and described. As will be realized, the invention is capable of modification in various respects, all without departing from the invention. Accordingly, the drawings and description are to be regarded as illustrative in nature, and not restrictive.

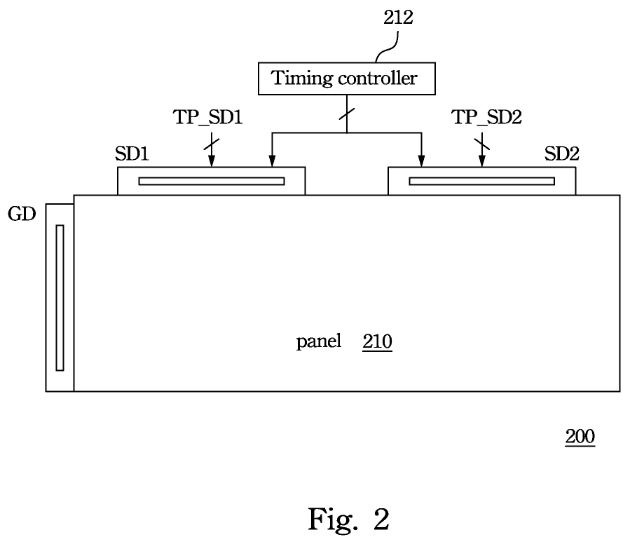

FIG. 2 illustrates a display according to an embodiment of the invention. The display 200 includes a panel 210, a timing controller 212, source drivers SD1 and SD2, and a gate driver GD. The panel 210 comprises pixels arranged in an array. The timing controller 212 is coupled to the source drivers SD1 and SD2 and transmits transfer pulses TP_SD1 and TP_SD2, which are different in phase, to the source drivers SD1 and SD2, respectively. In another embodiment, the timing controller 212 is coupled to the source drivers SD1 and SD2 via control lines respectively and transmits the transfer pulses TP_SD1 and TP_SD2 via the respective control lines to the source drivers SD1 and SD2. Pixels on the same row are connected to a gate line controlled by the gate driver GD, and driven by the source drivers SD1 and SD2. During one line period, the gate driver GD selectively activates one of the gate lines, and source drivers SD1 and SD2 output driving voltages, in response to the transfer pulses TP_SD1 and TP_SD2, to the pixels corresponding to the selected gate line. The transfer pulses TP_SD1 and TP_SD2 have different timing from each other in this embodiment during a line period, such that the source driver SD2 outputs driving voltages shortly after the source driver SD1.

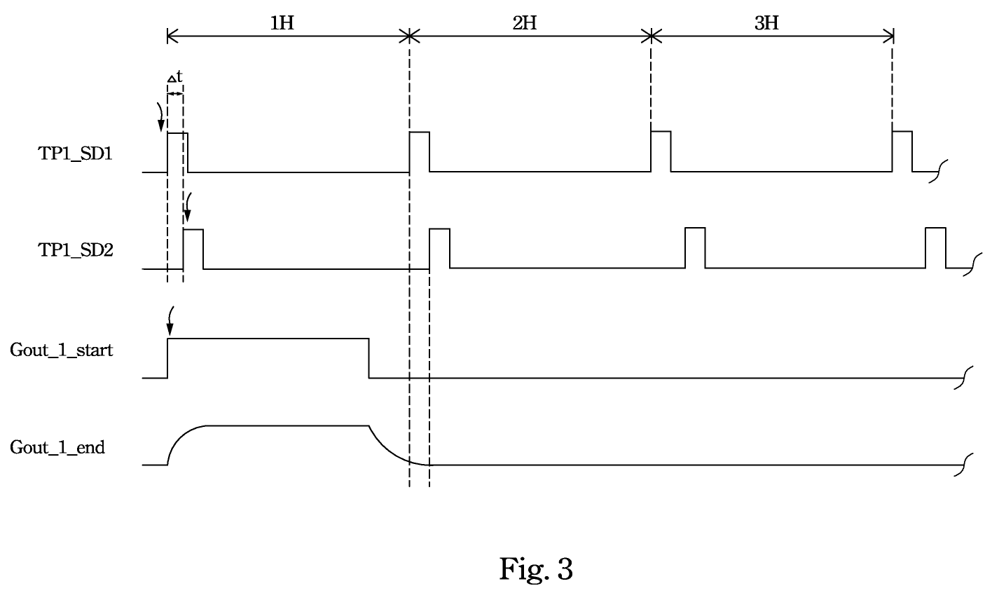

FIG. 3 illustrates a timing diagram of the transfer pulse and the gate driving signal according to one embodiment of the present invention. Referring to FIGS. 2 and 3, during a first line period 1H, initially the transfer pulse TP1_SD1 is generated for the first source driver SD1, a corresponding gate line (e.g. 1^{st} gate line) is activated by the gate driving signal Gout_1, and the source driver SD1 is triggered by the transfer pulse TP1_SD1 to drive the pixels corresponding to the 1^{st} gate line. Shortly thereafter, a transfer pulse TP1_SD2 lagging behind the start pulse TP1_SD1 is generated for the second source driver SD2 to drive the pixels corresponding to the 1^{st} gate line. The front pixels, corresponding to the front part of the 1^{st} gate line and driven by the first source driver SD1, receives the gate driving signal Gout_1 with a pulse shape as shown by Gout_1_start; while the end pixels, corresponding to the ending part of the 1^{st} gate line and driven by the second driver SD2, receives the gate driving signal Gout_1 with a pulse shape as shown by Gout_1_end due to the IR drop of the gate line.

Specifically, when the transfer pulse TP1_SD1 is asserted, the gate driving signal Gout_1 is initially generated to activate the gate line, and the gate driving signal Gout_1 has a waveform of the initial state (i.e. Gout_1_start). Then, after a first time interval (e.g. Δt), the transfer pulse TP1_SD2 lagging behind the start pulse TP1_SD1 is generated for the source driver SD2 to start driving the corresponding pixels for the first gate line. After the gate driving signal Gout_1 is transmitted to the end of the gate line, the waveform of the gate driving signal Gout_1 becomes the waveform of Gout_1_end. Due to the delayed transfer pulse TP1_SD2, the Gout_1_end can become un-asserted in time before the next transfer pulse TP2_SD2 (for next gate line) is asserted. Therefore the display quality is enhanced since the gate line can be timely de-activated before next gate line is activated. For this multi-timing-transfer-pulse technique, the duration of gate driving signal can be lengthened, compared to that in the prior art, such that the charging time for each pixel is lengthened.

Furthermore, the aforementioned transfer pulses TP_SDL and TP_SD2 can be sequentially generated by a timing controller, or sequentially generated according to the corresponding source drivers. The time interval Δt can be determined by the timing controller or the source drivers, and it can be constant or variable according to different display timings, for example according to the corresponding gate lines.

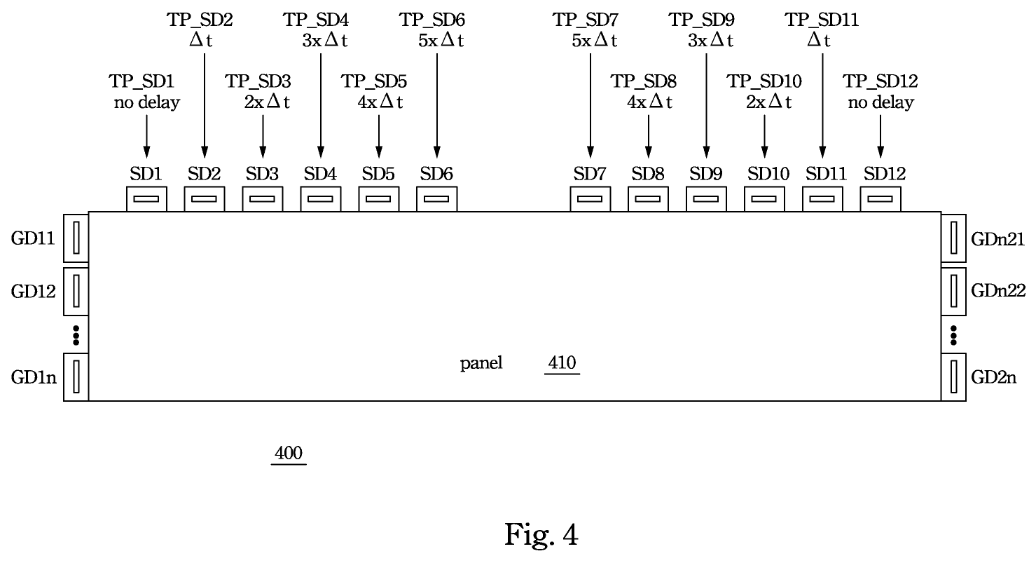

FIG. 4 illustrates a display according to another embodiment of the present invention. The display 300 includes a timing controller (not shown), a panel 410, source drivers (i.e. SD1, SD2, . . . and SD12), gate drivers GD11, GD12, . . . and GD1n, and gate drivers GD21, GD22, . . . , and GD2n. The gate drivers GD11, GD12, . . . and GD1n are disposed on one side of the panel 410 to control the gate lines. The gate drivers GD21, GD22, . . . , and GD2n are disposed on the other side of the panel 410 to control the gate lines. In one embodiment the gate lines are controlled both by the gate drivers at two sides of the panel, and in another embodiment the gate lines are divided into right gate lines and left gate lines respectively controlled by the gate drivers at two sides of the panel 410.

During a line period, the transfer pulses for source drivers are different. For example, the transfer pulse TP_SD2 is asserted after Δt behind the asserted transfer pulse TP_SD1, . . . , and the transfer pulse TP_SD6 is asserted after 5xΔt behind the asserted transfer pulse TP_SD1. Because panel 410 is driven by the gate drivers on two sides of the panel 410, the distortion of the gate driving signal is most serious in the middle of the panel, and thus the source drivers corresponding to the pixels in the middle of the gate line, SD6 and SD7, receive the transfer pulses with greatest delays. It should be noted that the delay times between source drivers may be variable, other than the fixed delta value in the above example.

Notably, for the foregoing embodiments, the source drivers can receive an original transfer pulse, and each source driver generates its own transfer pulse by delaying the original transfer pulse for different periods. For example, the source driver SD1 receives the transfer pulse TP_SD1, the source driver SD2 generates its own transfer pulse TP_SD2 by delaying the transfer pulse TP_SDL for a certain period, and so forth. Furthermore, the foregoing transfer pulses, received or generated by the source drivers, can be different in pulse widths.

For the foregoing embodiments, the multi-timing-transfer-pulse display can be provided to extend the activated period (or width) of the gate driving signal, such that the charging time of pixels in the display can be extended, and the pixels can be more easily charged to the objective voltage level. Furthermore, the multi-timing-transfer-pulse display also can be provided to solve the problem that the gate driving signal seriously decays when the circuit loading increases, and the problem that the period of the gate driving signal becomes too short when the operating frequency of the display (i.e. frequency of generation of the start pulse for the gate driver) increases.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A display comprising:
a panel comprising a plurality of pixels arranged in an array;
a gate driver for selectively activating a gate line of the panel; and
a plurality of source drivers, during a line period, receiving a plurality of transfer pulses, each of the transfer pulses corresponding to one of the source drivers, and the source drivers driving one row of the pixels corresponding to the activated gate line, while triggered by the corresponding transfer pulse, wherein the transfer pulses are not all identical.

2. The display of claim 1, further comprising:
a timing controller, coupled to the source driver, for transmitting the transfer pulses to the source drivers.

3. The display of claim 1, further comprising:
a timing controller, coupled to the source drivers via a plurality of control lines respectively, for transmitting the transfer pulses respectively via the respective control lines.

4. The display of claim 1, wherein the source drivers receive an original transfer pulse, and each source driver generates its own transfer pulse by delaying the original transfer pulse for different periods.

5. The display of claim 1, wherein the transfer pulses are different in phase.

6. The display of claim 1, wherein the transfer pulses are different in pulse widths.

7. A method for driving a display, the display including a plurality of source drivers and a panel, the method comprising:
receiving a plurality of transfer pulses, during a line period, respectively corresponding to the source drivers, wherein the transfer pulse signals are not all identical; and
driving the panel by the corresponding source drivers upon receiving the corresponding transfer pulse.

8. The method of claim 7, wherein the transfer pulses are generated by a timing controller of the display.

9. The method of claim 7, wherein the transfer pulses are different in phases.

10. The method of claim 7, wherein the transfer pulses are different in pulse widths.
